(19) United States
(12) Patent Application Publication
(10) Pub. No.: US 2026/0154068 A1
(43) Pub. Date: Jun. 4, 2026

(54) COMPUTING SYSTEM FOR VERSION CONTROL WITH POST MERGE CONFLICT CHECK

(71) Applicant: Lemon Inc., Grand Cayman (KY)

(72) Inventor: Pengwen Jiao, Culver City, CA (US)

(21) Appl. No.: 18/969,086

(22) Filed: Dec. 4, 2024

(51) Int. Cl. G06F 8/71

(52) U.S. Cl. CPC G06F 8/71

(57) ABSTRACT

A computing system with instructions that when executed cause processing circuitry to execute a version control program. The version control program is configured to detect a merge completion in the version control program, and upon detecting the merge completion, determine that a post merge conflict check trigger condition is met. Upon determining that the post merge conflict check trigger condition is met, the version control program is configured to perform a post merge conflict check to determine whether a merge conflict exists in merged code in the version control program. After determining that the merge conflict exists the version control program is configured to set metadata indicating the merged code is broken, compare the merged code with a last known good revision, obtain differences between the merged code and the last known good revision, and output a first merge conflict notification that indicates a merge conflict exists.

### BACKGROUND

When developers in a multi-collaborative project work on a code file each developer typically works in a developer specific branch of the code using a version control platform. When the developer has finished making edits in their developer's branch, they request to merge the code they have developed with the main development branch. However, when two or more developers work on a code file in parallel the edits made by the developers to the code file in their respective developer's branches may conflict with each other. For example, one developer may remove an application programming interface (API) that another developer added further code to.

In existing methods of addressing merge conflicts, edits made by a developer are typically checked for conflicts when that developer requests to merge the edited version of the code file with the main development branch. However, when two or more developers work on a code file in parallel the merge conflict does not consider the latest version of the main development branch that would take into account the other developer's edits.

### SUMMARY

In view of the above, a computing systems and methods for post merge conflict checks are provided comprising. In one aspect, the computing system comprises processing circuitry and memory storing instructions that when executed by the processing circuitry cause the processing circuitry to execute a version control program. The version control program is configured to detect a merge completion in the version control program and upon detecting the merge completion, determine that a post merge conflict check trigger condition is met. The version control program is further configured to, upon determining that the post merge conflict check trigger condition is met, perform a post merge conflict check to determine whether a merge conflict exists in merged code in the version control program. The version control system is further configured to determine that the merge conflict exists, then set metadata indicating the merged code is broken, compare the merged code with a last known good revision, obtain differences between the merged code and the last known good revision, and output a first merge conflict notification that indicates the merge conflict exists.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing environment according to an example of the present disclosure.

FIG. 2 shows a schematic diagram of an example control flow of the version control program of FIG. 1.

FIGS. 3A-3B show example graphical user interfaces (GUIs) of a first merge conflict notification, according to the embodiment of FIG. 1.

FIG. 4 shows an example GUI of a rollback notification, according to the embodiment of FIG. 1.

FIGS. 5A-5B show example GUIs of an issue check notification, according to the embodiment of FIG. 1.

FIG. 6 shows a flow chart of a method for performing a post merge conflict check for the computing system of FIG. 1.

FIG. 7 shows an example computing environment of the present disclosure in which the computing system of FIG. 1 may be enacted.

### DETAILED DESCRIPTION

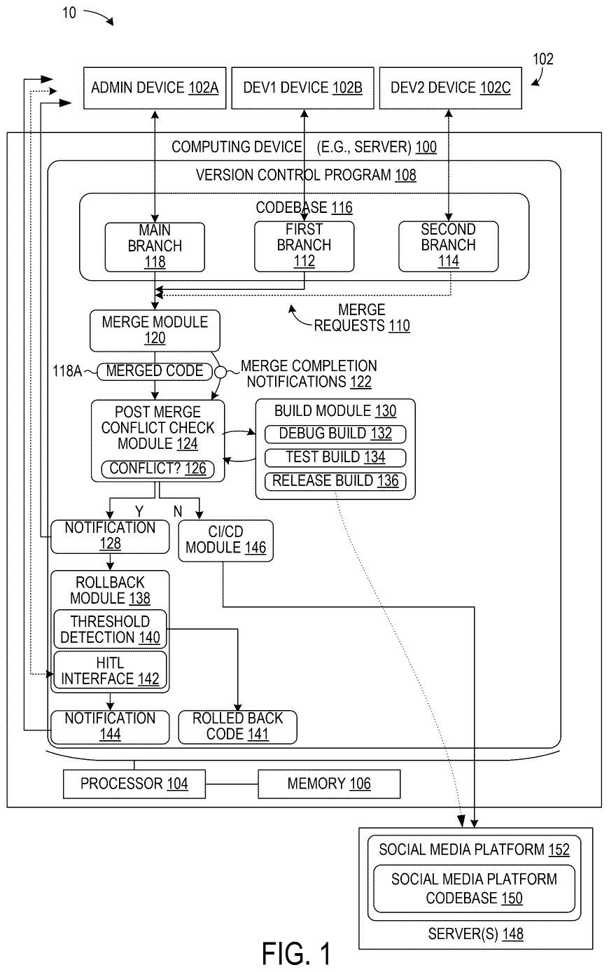

FIG. 1 shows a schematic view of a first example computing system 10 including a computing device 100 for performing post merge conflict checks using a post merge conflict check module 124. The computing device 100 is configured to interface with a plurality of user computing devices 102 including admin device 102A, a first developer device 102B, and a second developer device 102C. The computing device 100 may include a processor 104 and memory 106. The computing device 100 may further include a version control program 108 configured to control and track different versions of a codebase 116. For example, the version control program 108 can be used to manage edits made to codebase 116 by a first developer on the first developer device 102B to a first code branch 112 of codebase 116, and similarly can manage edits by a second developer.

Memory 106 stores instructions that when executed by processor 104 causes processor 104 to execute the version control program 108 that is configured to receive merge requests 110 from user computing devices 102 for a first code branch 112 and/or a second code branch 114 of a codebase 116 to merge the first code branch 112 and/or the second code branch 114 with a main branch 118 of codebase 116. In this example, a first developer device 102B has been used to author a first branch 112 of codebase 116, second developer device 102C has been used to author second branch 114 of codebase 116, and admin device 102A is used by an admin for the codebase to control the operations (including merge operations) performed on the main branch 118 of codebase 116.

The version control program 108 is further configured to execute merge module 120 after receiving merge requests 110. Merge module 120 is configured to perform pre-merge conflict checks. The first code branch 112 and/or the second code branch 114 are input into merge module 120 to perform pre-merge conflict checks on the first code branch 112 and/or the second code branch 114. Pre-merge conflicts can include conflicts between the first code branch 112 or the second code branch 114 and the main branch 118, such as undeclared variables, missing libraries or APIs, etc. Pre-merge conflicts are typically detected by comparing the first code branch 112 or the second code branch 114 with the main branch without taking into account other merge requests that resulted in edits to the main branch. As such, pre-merge conflict checks only consider code on the main branch 118 prior to merge. When the merge module 120 detects no pre-merge conflicts, the first code branch 112 or second code branch 114 is merged with the main branch 118 to form merged code 118A on the main branch 118, and a merge completion notification 122 is output from the merge module 120.

The version control program 108 is further configured to execute post merge conflict check module 124 after detecting merge completion (e.g., by receiving the merge completion notification 122) in the version control program 108 and determining that a post merge conflict check trigger condition is met. The post merge conflict check module 124 performs post merge conflict checks to determine whether a merge conflict exists in merged code 118A in main branch 118 in the version control program 108. If a conflict 126 is determined to exist by the post merge conflict check module 124, the version control program 108 is further configured to output a notification 128 to user computing devices 102 after executing the post merge conflict check module 124. In some examples, notification 128 can comprise a first merge conflict notification that indicates the merge conflict exists. Further, if the conflict 126 is determined to exist, the post merge conflict check module 124 can include setting metadata indicating the merged code is broken, comparing the merged code with a last known good revision, and obtaining differences between the merged code and the last known good revision.

The version control program 108 is further configured to execute a build module 130. The build module 130 includes a debug build 132, a test build 134, and a release build 136. The build module 130 is configured to communicate with the post merge conflict check module 124 and make these various builds available to the post merge conflict check module 124. For example, the post merge conflict check module 124 is configured to perform post merge conflict checks using the debug build 132, the test build 134, the release build 136, and/or other builds. In some examples, the version control program 108 is configured to execute the post merge conflict check module 124 and the build module 130 concurrently. In other examples, the version control program 108 is configured to execute the post merge conflict check module 124 and the build module 130 at different times.

The version control program 108 is further configured to execute rollback module 138 if the conflict 126 is determined to exist by the post merge conflict check module 124. Rollback module 138 includes threshold detection 140 and human-in-the-loop (HITL) interface 142. The version control program 108 is configured to output a notification 144 to user computing devices 102 after executing the rollback module 138.

The threshold detection 140 is configured to determine whether differences between two versions of codebase 116 should be rolled back based on whether a rollback trigger condition is met. In some examples, the rollback trigger condition includes a number of differences between the merged code and the last known good revision. Threshold detection 140 is configured to, if the rollback trigger condition is met, rollback the differences to form rolled back code 141. Further if the rollback trigger condition is met, outputting notification 144 can comprise outputting a rollback notification indicating that the differences were rolled back and rolled back code 141 was formed.

The HITL interface 142 is configured to communicate with user computing devices 102 including admin device 102A, first developer device 102B, and/or second developer device 102C and, if a rollback trigger condition is not met, create an issue check channel. If the rollback trigger condition is not met, outputting notification 144 can comprise outputting an issue check notification indicating that the issue check channel was created.

After outputting notification 144, the version control program 108 can be further configured to execute the merge module 120, the post merge conflict check module 124, the build module 130, and the rollback module 138 a plurality of additional times. In some examples, an additional merge conflict check can be performed by the post merge conflict check module 124 after detecting a second merge completion in a second merged code. In such examples, the version control program 108 can be further configured to determine that a merge conflict does not exist in the second merged code, remove metadata indicating a first merged code is broken from the second merged code, and set metadata indicating that the second merged code is the last known good revision. The last known good revision indicates that the second merged code is the latest version of main branch 118 and as such is safe for other developers to further edit.

The version control program 108 is further configured to execute a continuous integration/continuous development (CI/CD) module 146 if the conflict 126 is determined not to exist by the post merge conflict check module 124. The CI/CD module 146 is configured to communicate with server(s) 148 and is further configured to output a social media platform codebase 150 on a social media platform 152. Although depicted as distinct devices in FIG. 1, it will be appreciated that server(s) 148 can be the same device as computing device 100, in some configurations. In some examples, if the conflict 126 does not exist, release build 134 can be input into the CI/CD module 146 such that the release build 134 is published on the server(s) 148 to the social media platform codebase 150.

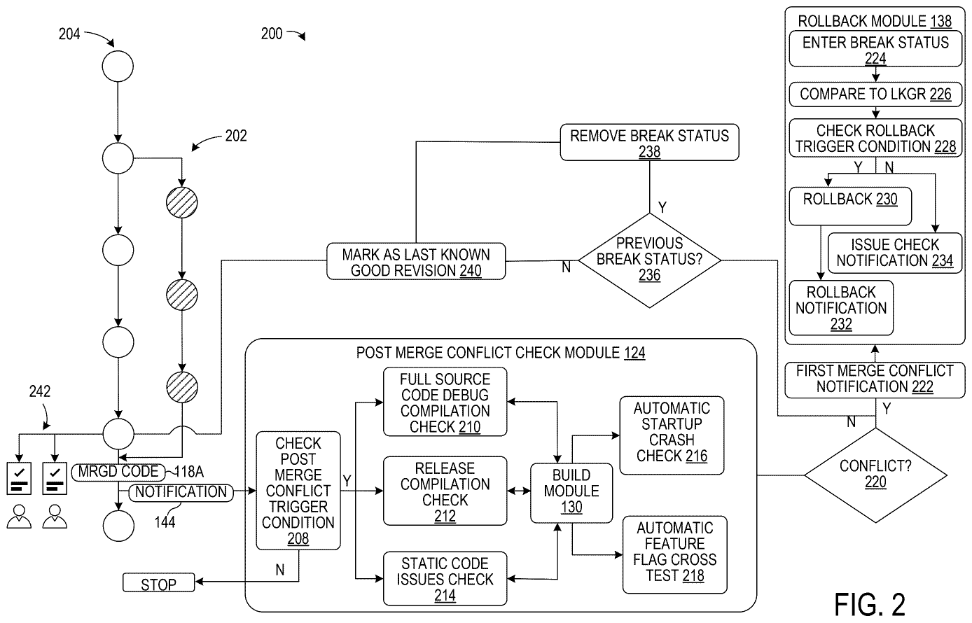

FIG. 2 schematically shows an example of executing a post merge conflict check 200 using the post merge conflict check module 124, the build module 130, and the rollback module 138 to determine if a post merge conflict exists in merged code from a developer branch 202 in a main branch 204. In some examples, developer branch 202 can comprise first branch 112. In other examples, developer branch 202 can comprise second branch 114. In some examples, main branch 204 can comprise main branch 118.

Prior to performing the post merge conflict check module 124, the developer branch 202 can submit a merge request to merge the developer branch 202 with the main branch 204 to form merged code 118A. After forming the merged code 118A a merge completion notification 122 can be output. In some examples, merge module 120 can be utilized to merge the developer branch 202 with the main branch 204 to form the merged code 118A and output merge completion notification 122.

After outputting the merge completion notification 122, the post merge conflict check 200 comprises executing the post merge conflict check module 124. The post merge conflict check module 124 comprises, at 208, checking for a post merge conflict trigger condition. If the post merge conflict trigger condition is met at 208, then the post merge conflict check module 124 continues to determine whether a merge conflict exists. If the post merge conflict trigger is not met at 208, then the post merge conflict check 200 stops. In some examples the post merge conflict trigger can include an amount of time that has passed since a prior post merge conflict check was performed. In other examples, the post merge conflict trigger can include a number of merge completions detected. In even further examples, the post merge conflict trigger can include both an amount of time that has passed since a prior post merge conflict check was performed and a number of merge completions detected.

Upon determining that the post merge conflict trigger condition is met, the post merge conflict check 200 is accomplished at least in part by a running full source code debug compilation check 210 on the merged code 118A. Additionally, the post merge conflict check 200 is accomplished at least in part by building a release codebase, using the build module 130, and running a release compilation check 212 on the release codebase. Further, the post merge conflict check 200 is accomplished at least in part by running a static code issues check 214. In some examples, static code issues check can check for syntax errors in the merged code 118A.

Even further, the post merge conflict check 200 is accomplished at least in part by performing an automatic startup crash check 216 to determine whether a build of the merged code 118A will successfully start up within a predetermined period of time. In some examples the predetermined amount of time can include a time in the range of 1 second to 10 seconds. In other examples, any suitable time can be used. Additionally, the post merge conflict check 200 is accomplished at least in part by performing an automatic feature flag cross test 218 to determine whether a plurality of feature flags cause errors in a build of the merged code 118A.

In some examples, the post merge conflict check further comprises building a plurality of different test builds, using build module 130, and performing the post merge conflict check on the plurality of different test builds. The test builds can be run through the full source code debug compilation check 210, the release compilation check 212, the static code issues check 214, the automatic startup crash check 216, and the automatic feature flag cross test 218.

After executing the post merge conflict module 124 it is determined, at 220, whether a merge conflict exists. If a merge conflict exists a first merge conflict notification 222 is output to both the developer using the developer branch 202 and admin using the main branch 204. In some examples, the first merge conflict notification 222 indicates to the developer that there is a merge conflict in the merged code 118A and that the latest branch, developer branch 202, is not safe to use due to the merge conflict. As such, the notification enables the developer to avoid working on code that contains a merge conflict. In other examples, the first merge conflict notification 222 indicates to the admin that there is a merge conflict in the merged code 118A and that the admin should follow up with the merge conflict.

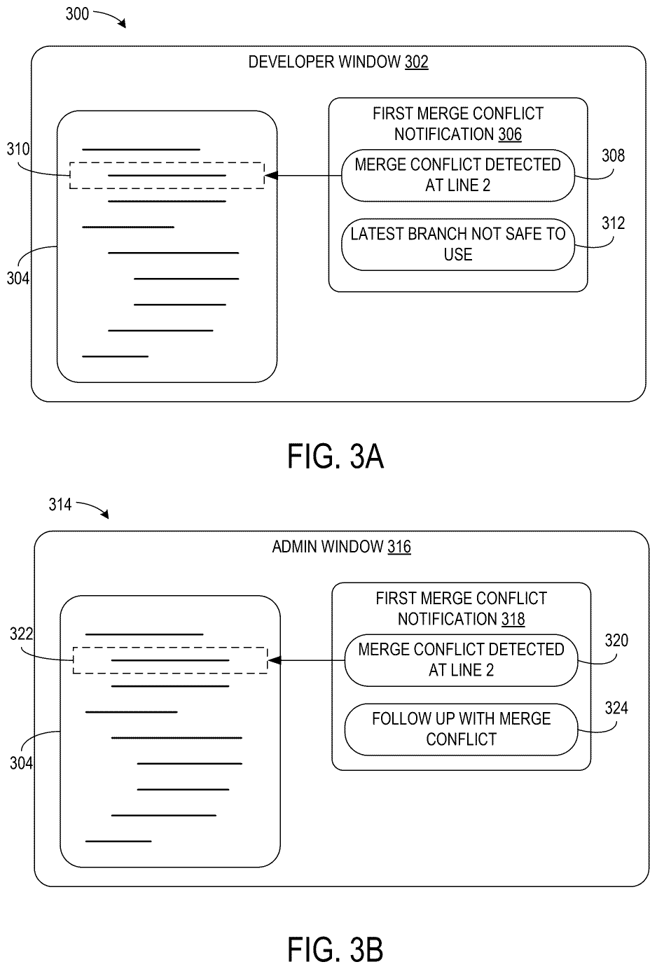

FIG. 3A shows an example first merge conflict notification 222 on an example developer window 302 of a graphical user interface (GUI) 300, including a code file 304 and a first merge conflict notification 306. The developer window 302 and the GUI 300 can be included on a display device associated with first developer device 102B and/or on a display device associated with second developer device 102C. The first merge conflict notification 306 includes indication 308 that indicates “merge conflict detected at line 2,” shown at 310. The first merge conflict notification 306 further includes indication 312 that indicates “latest branch not safe to use.”

FIG. 3B shows an example first merge conflict notification on an example admin window 316 of a GUI 314, including a code file 304 and a first merge conflict notification 318. The admin window 316 and the GUI 314 can be included on a display device associated with admin device 102A. The first merge conflict notification 318 includes indication 320 that indicates “merge conflict detected at line 2,” shown at 322. The first merge conflict notification 318 further includes indication 324 that indicates “follow up with merge conflict.”

Returning to FIG. 2, after outputting the first merge conflict notification 222, the post merge conflict check 200 comprises executing the rollback module 138. The rollback module 138 comprises entering a break status at 224. Entering a break status, at 224, includes setting metadata that indicates that the merged code 118A is broken due to the merge conflict detected. The rollback module 138 further comprises, at 226, comparing the merged code 118A with a last known good revision. The last known good revision is a latest version of the codebase that was determined to not have a conflict present. When comparing the merged code 118A to the last known good revision at 226, the rollback module 138 includes obtaining differences between the merged code 118A and the last known good revision.

The rollback module 138 further comprises, at 228 checking a rollback trigger condition. In some examples the rollback trigger condition can include a number of differences between the merged code 118A and the last known good revision. In such examples, the number of differences can include 2 to 20 differences between the merged code 118A and the last known good revision. In other examples, the number of differences can be greater than or less than that range. In other examples, the rollback trigger condition can include a number of lines of code that contain differences.

If the rollback trigger condition is met, then the rollback module is configured to, at 230, rollback the differences between the merged code 118A and the last known good revision, to form a rolled back code 141, such that the rolled back code 141 is the same as the last known good revision. After the differences are rolled back, a rollback notification 232 is output to developer using developer branch 202.

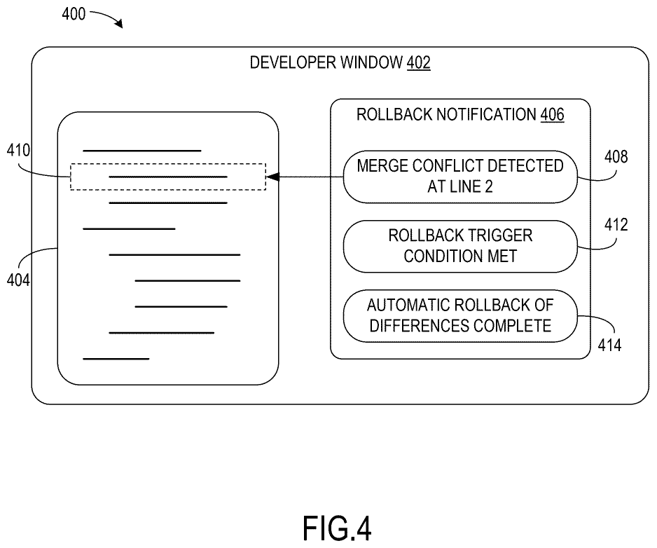

FIG. 4 shows an example rollback notification 232 on an example developer window 402 of a graphical user interface (GUI) 400, including code file 404 and a rollback notification 406. The developer window 402 and the GUI 400 can be included on a display device associated with first developer device 102B and/or on a display device associated with second developer device 102C. The rollback notification 406 includes indication 408 that indicates “merge conflict detected at line 2,” shown at 410. The rollback notification 406 further includes indication 412 that indicates “rollback trigger condition met.” The rollback notification 406 further includes indication 414 that indicates “automatic rollback of differences complete.”

Returning to FIG. 2, if the rollback trigger condition is not met at 228, then the rollback module 138 comprises outputting issue check notification 234. The issue check notification 234 is sent to both the developer branch 202 and the main branch 204. The issue check notification 234 indicates that the rollback trigger condition was not met and an issue check channel was created. The issue check channel creates a channel where the differences between the merged code 118A and the last known good revision can be analyzed. After correcting the merge conflicts detected in the merged code 118A, the merge code can be checked again for merge conflicts using the merge conflict check 200.

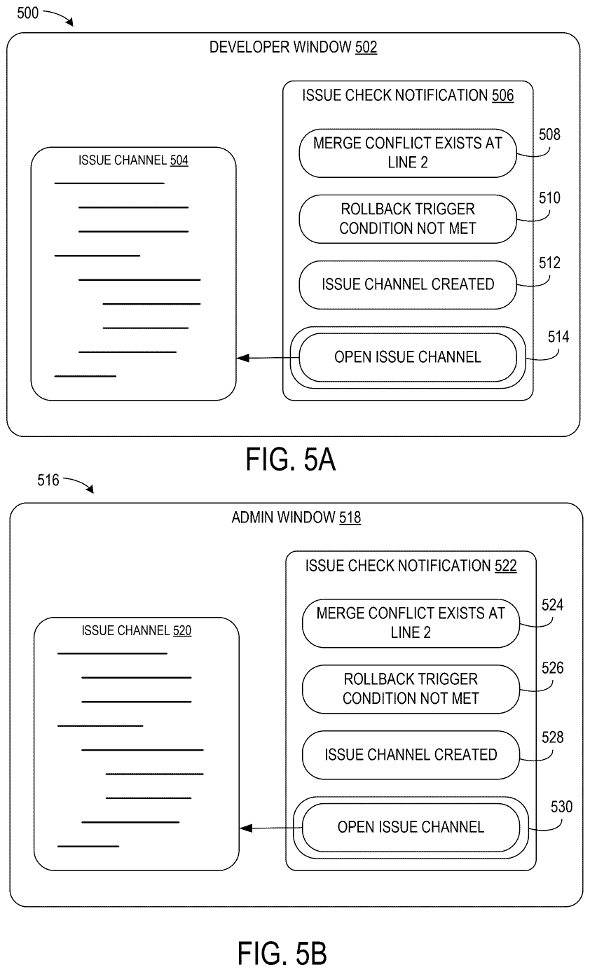

FIG. 5A shows an example issue check notification 234 on an example developer window 502 of a GUI 500, including an issue channel 504 and an issue check notification 506. The developer window 502 and the GUI 500 can be included on a display device associated with first developer device 102B and/or on a display device associated with second developer device 102C. The issue check notification 506 includes indication 508 that indicates “merge conflict exists at line 2.” The issue check notification 506 further includes indication 510 that indicates “rollback trigger condition not met.” The issue check notification 506 further includes indication 512 that indicates “issue channel created.” The issue check notification 506 further includes an option 514 to open the issue channel 504. The option 514 indicates, “open issue channel.” When option 514 is selected the issue channel 504 may be opened on the developer window 502 of the GUI 500.

FIG. 5B shows an example issue check notification 234 on an example admin window 518 of a GUI 516, including an issue channel 520 and an issue check notification 522. The admin window 518 and the GUI 516 can be included on a display device associated with admin device 102A. The issue check notification 522 includes indication 524 that indicates “merge conflict exists at line 2.” The issue check notification 522 further includes indication 526 that indicates “rollback trigger condition not met.” The issue check notification 522 further includes indication 528 that indicates “issue channel created.” The issue check notification 522 further includes an option 530 to open the issue channel 520. The option 530 indicates, “open issue channel.” When option 530 is selected the issue channel 520 may be opened on the developer window 518 of the GUI 516.

Returning to FIG. 2, if a conflict is determined not to exist at 220, then the post merge conflict check comprises, at 236, determining if a previous break status was entered. A previous break status can indicate that a previous version of the merged code 118A was determined to have a conflict present at 220 and contained metadata indicating the merged code 118A was broken. If a previous break status was entered, then the break status is removed at 238, and then the merged code 118A is marked as the last known good revision at 240. If a previous break status was not entered, then the post merge conflict check 200 marks the merged code 118A as the last known good revision at 240. After marking the merged code 118A as the known good revision at 240, other developers can successfully work on the merged code 118A in the main branch 204, as indicated at 242.

Utilizing the post merge conflict check 200 can increase the stability assurance of the main branch 204 when multiple developers are working on their own branch by providing checks for merged code in addition to pre-merge checks. It is thought that the post merge conflict check 200 may reduce loss of research and development efficiency caused by stability issues in the main branch by up to 70% when compared to only performing pre-merge conflict checks.

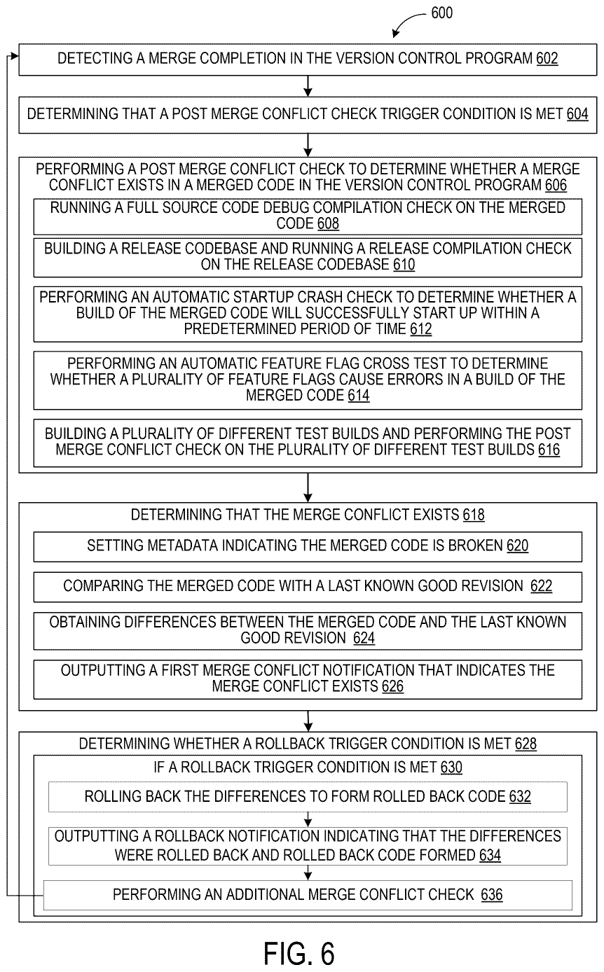

FIG. 6 shows a flowchart of a method 600 for use with a computing device, which may in some embodiments be the computing device 100 of FIG. 1. At step 602 the method 600 comprises detecting a merge completion in the version control program. At step 604, upon detecting the merge completion, the method 600 further comprises determining that a post merge conflict check trigger condition is met. In some examples the post merge conflict trigger can include an amount of time that has passed since a prior post merge conflict check was performed. In other examples, the post merge conflict trigger can include a number of merge completions detected. In even further examples, the post merge conflict trigger can include both an amount of time that has passed since a prior post merge conflict check was performed and a number of merge completions detected. In other examples, any suitable post merge conflict trigger can be used.

At step 606, upon determining that the post merge conflict check trigger condition is met, the method 600 comprises performing a post merge conflict check to determine whether a merge conflict exists in merged code in the version control program. Performing the post merge conflict check is accomplished at least in part by, at step 608, running a full source code debug compilation check on the merged code. Performing the post merge conflict check is accomplished at least in part by, at step 610, building a release codebase and running a release compilation check on the release codebase. Performing the post merge conflict check is accomplished at least in part by, at step 612, performing an automatic startup crash check to determine whether a build of the merged code will successfully start up within a predetermined period of time. Performing the post merge conflict check is accomplished at least in part by, at step 614, performing an automatic feature flag cross test to determine whether a plurality of feature flags cause errors in a build of the merged code. Performing the post merge conflict check is accomplished at least in part by, at step 616, building a plurality of different test builds and performing the post merge conflict check on the plurality of different test builds.

At step 618, the method 600 comprises determining that a merge conflict exists. After determining that the merge conflict exists at step 618, the method 600 comprises, at step 620, setting metadata indicating that the merged code is broken. The method 600 further comprises, at step 622, comparing the merged code with a last known good revision. As discussed above, the last known good revision is a latest version of the codebase that was determined to not have a conflict present.

At step 624, the method 600 comprises obtaining differences between the merged code and the last known good revision. Method 600 further comprises, at step 626, outputting a first merge conflict notification that indicates the merge conflict exists.

At step 628, the method 600 comprises determining whether a rollback trigger condition is met. In some examples the rollback trigger condition can include a number of differences between the merged code and the last known good revision. In such examples, the number of differences can include 2 to 20 differences between the merged code and the last known good revision. In other examples, the number of differences can be greater than or less than that range.

If a rollback trigger condition is met at step 630, the method 600 comprises, at step 632, rolling back the differences to form a rolled back code. After rolling back the differences, at step 634, the method 600 comprises outputting a rollback notification indicating that the differences were rolled back and rolled back code was formed.

At step 636, method 600 comprises performing an additional merge conflict check. Performing an additional merge conflict check can comprise returning to step 602. In some examples performing the additional merge conflict check includes performing steps 608-616.

In some embodiments, the methods and processes described herein may be tied to a computing system of one or more computing devices. In particular, such methods and processes may be implemented as a computer-application program or service, an application-programming interface (API), a library, and/or other computer-program product.

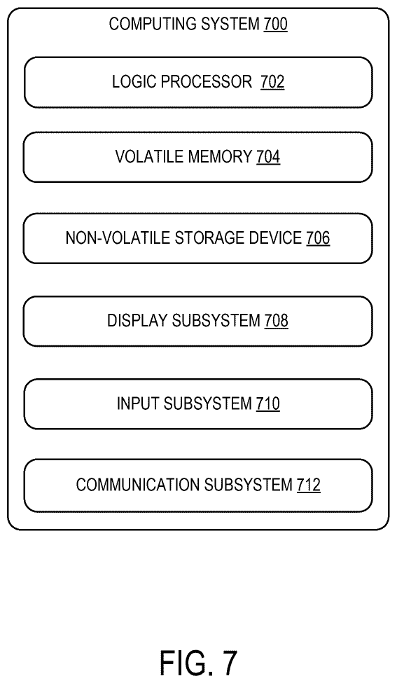

FIG. 7 schematically shows a non-limiting embodiment of a computing system 700 that can enact one or more of the methods and processes described above. Computing system 700 is shown in simplified form. Computing system 700 may embody the computing device 100, servers(s) 148, and user computing devices 102 of computing system 10 described above and illustrated in FIG. 1. Computing system 700 may take the form of one or more personal computers, server computers, tablet computers, home-entertainment computers, network computing devices, gaming devices, mobile computing devices, mobile communication devices (e.g., smart phone), and/or other computing devices, and wearable computing devices such as smart wristwatches and head mounted augmented reality devices.

Computing system 700 includes a logic processor 702 volatile memory 704, and a non-volatile storage device 706. Computing system 700 may optionally include a display subsystem 708, input subsystem 710, communication subsystem 712, and/or other components not shown in FIG. 7.

Logic processor 702 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 706 includes one or more physical devices configured to hold instructions executable by the logic processors to implement the methods and processes described herein. When such methods and processes are implemented, the state of non-volatile storage device 706 may be transformed—e.g., to hold different data.

Non-volatile storage device 706 may include physical devices that are removable and/or built in. Non-volatile storage device 706 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 706 may include nonvolatile, dynamic, static, read/write, read-only, sequential-access, location-addressable, file-addressable, and/or content-addressable devices. It will be appreciated that non-volatile storage device 706 is configured to hold instructions even when power is cut to the non-volatile storage device 706.

Volatile memory 704 may include physical devices that include random access memory. Volatile memory 704 is typically utilized by logic processor 702 to temporarily store information during processing of software instructions. It will be appreciated that volatile memory 704 typically does not continue to store instructions when power is cut to the volatile memory 704.

Aspects of logic processor 702, volatile memory 704, and non-volatile storage device 706 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included display subsystem 708 may be used to present a visual representation of data held by non-volatile storage device 706. The visual representation may take the form of a graphical user interface (GUI). As the herein described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices.

When included input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local-or wide-area network, such as a HDMI over Wi-Fi connection. In some embodiments, the communication subsystem may allow computing system 700 to send and/or receive messages to and/or from other devices via a network such as the Internet.

The following paragraphs provide additional description of the subject matter of the present disclosure. One aspect provides a computing system, comprising processing circuitry and memory storing instructions that when executed by the processing circuitry cause the processing circuitry to execute a version control program configured to detect a merge completion in the version control program, upon detecting the merge completion, determine that a post merge conflict check trigger condition is met, upon determining that the post merge conflict check trigger condition is met, perform a post merge conflict check to determine whether a merge conflict exists in merged code in the version control program, determine that the merge conflict exists, and upon determining that the merge conflict exists: set metadata indicating the merged code is broken, compare the merged code with a last known good revision, obtain differences between the merged code and the last known good revision, and output a first merge conflict notification that indicates the merge conflict exists. In this aspect, additionally or alternatively, the version control program is further configured to, after outputting the first merge conflict notification, determine whether a rollback trigger condition is met, and if the rollback trigger condition is met, then rollback the differences, output a rollback notification indicating that the differences were rolled back, and perform an additional merge conflict check. In this aspect, additionally or alternatively, the rollback trigger condition includes a number of differences between the merged code and the last known good revision. In this aspect, additionally or alternatively, performing the additional merge conflict check further comprises, in the case that the merge completion is a first merge completion, and the merged code is a first merged code, and following output of the rollback notification, the version control program is configured to, in the additional merge conflict check, detect a second merge completion in a second merged code, perform a post merge conflict check to determine whether a merge conflict exists in the second merged code, determine that a merge conflict does not exist in the second merged code, remove the metadata indicating the first merged code is broken from the second merged code, and set metadata indicating that the second merged code is the last known good revision. In this aspect, additionally or alternatively, the version control program is further configured to, after outputting the first merge conflict notification, determine whether a rollback trigger condition is met, if the rollback trigger condition is not met, then create an issue check channel, and output an issue check notification indicating that the rollback trigger condition was not met, and the issue check channel was created. In this aspect, additionally or alternatively, the post merge conflict check is accomplished at least in part by running a full source code debug compilation check on the merged code. In this aspect, additionally or alternatively, the post merge conflict check is accomplished at least in part by building a release codebase and running a release compilation check on the release codebase. In this aspect, additionally or alternatively, the post merge conflict check is accomplished at least in part by performing an automatic startup crash check to determine whether a build of the merged code will successfully start up within a predetermined period of time. In this aspect, additionally or alternatively, the post merge conflict check is accomplished at least in part by performing an automatic feature flag cross test to determine whether a plurality of feature flags cause errors in a build of the merged code. In this aspect, additionally or alternatively, the post merge conflict check further comprises building a plurality of different test builds and performing the post merge conflict check on the plurality of different test builds. In this aspect, additionally or alternatively, the trigger condition includes one or both of an amount of time that has passed since a prior post merge conflict check was performed and a number of merge completions detected.

Another aspect provides a method for performing a post merge conflict check, the method comprising detecting a merge completion in a version control program, upon detecting the merge completion, determining that a post merge conflict check trigger condition is met, upon determining that the post merge conflict check trigger condition is met, performing a post merge conflict check to determine whether a merge conflict exists in merged code in the version control program, determining that a merge conflict exists, and upon determining that the merge conflict exists: setting metadata indicating the merged code is broken, comparing the merged code with a last known good revision, obtaining differences between the merged code and the last known good revision, and outputting a first merge conflict notification that indicates the merged code is broken. In this aspect, additionally or alternatively, the method further comprises, after outputting the first merge conflict notification, determining whether a rollback trigger condition is met, and if a rollback trigger condition is met, then rolling back the differences, outputting a rollback notification indicating that the differences were rolled back, and performing an additional merge conflict check. In this aspect, additionally or alternatively, performing the additional merge conflict check further comprises, in the case that the merge completion is a first merge completion, and the merged code is a first merged code, and following output of the rollback notification, the version control program is configured to, in the additional merge conflict check, perform steps of detecting a second merge completion in the second merged code, determining that a merge conflict does not exist in the second merged code, removing the metadata indicating the first merged code is broken from the second merged code, and setting metadata indicating that the second merged code is the last known good revision. In this aspect, additionally or alternatively, the post merge conflict check is accomplished at least in part by running a full source code debug compilation check on the merged code. In this aspect, additionally or alternatively, the post merge conflict check is accomplished at least in part by building a release codebase and running a release compilation check. In this aspect, additionally or alternatively, the post merge conflict check is accomplished at least in part by performing an automatic startup crash check to determine whether a build of the merged code will successfully start up within a predetermined period of time. In this aspect, additionally or alternatively, the post merge conflict check is accomplished at least in part by performing an automatic feature flag cross test to determine whether a plurality of feature flags cause errors in a build of the merged code. In this aspect, additionally or alternatively, the post merge conflict check further comprises building a plurality of different test builds and performing the post merge conflict check on the plurality of different test builds.

Another aspect provides a method for performing Continuous Integration/Continuous Development (CI/CD) for a social media platform, the method comprising, detecting a merge completion in the version control program, upon detecting the merge completion, determining that a post merge conflict check trigger condition is met, upon determining that the post merge conflict check trigger condition is met, performing a post merge conflict check to determine whether a merge conflict exists in merged code in the version control program, wherein the post merge conflict check is accomplished at least in part by building a release codebase and running a release compilation check, if a merge conflict does not exist, then publishing the release codebase to a social media platform codebase.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
processing circuitry and memory storing instructions that when executed by the processing circuitry cause the processing circuitry to execute a version control program configured to:
detect a merge completion in the version control program;
upon detecting the merge completion, determine that a post merge conflict check trigger condition is met;
upon determining that the post merge conflict check trigger condition is met, perform a post merge conflict check to determine whether a merge conflict exists in merged code in the version control program; and
determine that the merge conflict exists, and upon determining that the merge conflict exists:
set metadata indicating the merged code is broken,
compare the merged code with a last known good revision,
obtain differences between the merged code and the last known good revision, and
output a first merge conflict notification that indicates the merge conflict exists.

2. The computing system of claim 1, wherein the version control program is further configured to, after outputting the first merge conflict notification, determine whether a rollback trigger condition is met, and
if the rollback trigger condition is met, then:
rollback the differences,
output a rollback notification indicating that the differences were rolled back, and
perform an additional merge conflict check.

3. The computing system of claim 2, wherein the rollback trigger condition includes a number of differences between the merged code and the last known good revision.

4. The computing system of claim 2, wherein performing the additional merge conflict check further comprises:
the merge completion is a first merge completion, and the merged code is a first merged code, and following output of the rollback notification, the version control program is configured to, in the additional merge conflict check:
detect a second merge completion in a second merged code;
perform a post merge conflict check to determine whether a merge conflict exists in the second merged code;
determine that a merge conflict does not exist in the second merged code;
remove the metadata indicating the first merged code is broken from the second merged code; and
set metadata indicating that the second merged code is the last known good revision.

5. The computing system of claim 1, wherein the version control program is further configured to, after outputting the first merge conflict notification, determine whether a rollback trigger condition is met, and
if the rollback trigger condition is not met, then:
create an issue check channel, and
output an issue check notification indicating that the rollback trigger condition was not met, and the issue check channel was created.

6. The computing system of claim 1, wherein the post merge conflict check is accomplished at least in part by running a full source code debug compilation check on the merged code.

7. The computing system of claim 1, wherein the post merge conflict check is accomplished at least in part by building a release codebase and running a release compilation check on the release codebase.

8. The computing system of claim 1, wherein the post merge conflict check is accomplished at least in part by performing an automatic startup crash check to determine whether a build of the merged code will successfully start up within a predetermined period of time.

9. The computing system of claim 1, wherein the post merge conflict check is accomplished at least in part by performing an automatic feature flag cross test to determine whether a plurality of feature flags cause errors in a build of the merged code.

10. The computing system of claim 1, wherein the post merge conflict check further comprises building a plurality of different test builds and performing the post merge conflict check on the plurality of different test builds.

11. The computing system of claim 1, wherein the trigger condition includes one or both of an amount of time that has passed since a prior post merge conflict check was performed and a number of merge completions detected.

12. A method for performing a post merge conflict check, the method comprising:
detecting a merge completion in a version control program;
upon detecting the merge completion, determining that a post merge conflict check trigger condition is met;
upon determining that the post merge conflict check trigger condition is met, performing a post merge conflict check to determine whether a merge conflict exists in merged code in the version control program;
determining that a merge conflict exists, and upon determining that the merge conflict exists:
setting metadata indicating the merged code is broken,
comparing the merged code with a last known good revision,
obtaining differences between the merged code and the last known good revision, and
outputting a first merge conflict notification that indicates the merged code is broken.

13. The method of claim 12, further comprising, after outputting the first merge conflict notification, determining whether a rollback trigger condition is met, and
if a rollback trigger condition is met, then:
rolling back the differences,
outputting a rollback notification indicating that the differences were rolled back, and
performing an additional merge conflict check.

14. The method of claim 13, wherein performing the additional merge conflict check further comprises:
the merge completion is a first merge completion, and the merged code is a first merged code, and following output of the rollback notification, the version control program is configured to, in the additional merge conflict check, perform steps of:
detecting a second merge completion in the second merged code;
determining that a merge conflict does not exist in the second merged code;
removing the metadata indicating the first merged code is broken from the second merged code; and
setting metadata indicating that the second merged code is the last known good revision.

15. The method of claim 12, wherein the post merge conflict check is accomplished at least in part by running a full source code debug compilation check on the merged code.

16. The method of claim 12, wherein the post merge conflict check is accomplished at least in part by building a release codebase and running a release compilation check.

17. The method of claim 12, wherein the post merge conflict check is accomplished at least in part by performing an automatic startup crash check to determine whether a build of the merged code will successfully start up within a predetermined period of time.

18. The method of claim 12, wherein the post merge conflict check is accomplished at least in part by performing an automatic feature flag cross test to determine whether a plurality of feature flags cause errors in a build of the merged code.

19. The computing system of claim 1, wherein the post merge conflict check further comprises building a plurality of different test builds and performing the post merge conflict check on the plurality of different test builds.

20. A method for performing Continuous Integration/Continuous Development (CI/CD) for a social media platform, the method comprising:
detecting a merge completion in the version control program;
upon detecting the merge completion, determining that a post merge conflict check trigger condition is met;
upon determining that the post merge conflict check trigger condition is met, performing a post merge conflict check to determine whether a merge conflict exists in merged code in the version control program, wherein the post merge conflict check is accomplished at least in part by building a release codebase and running a release compilation check;
if a merge conflict does not exist, then:
publishing the release codebase to a social media platform codebase.
